(19) United States
(12) Patent Application Publication
(10) Pub. No.: US 2004/0225656 A1
(43) Pub. Date: Nov. 11, 2004

(54) Web services method and system

(75) Inventor: Ajay Sarkar, San Diego, CA (US)

Correspondence Address: FOLEY & LARDNER, P.O. BOX 80278, SAN DIEGO, CA, 92138-0278, US

(73) Assignee: Panacea Corporation

(21) Appl. No.: 10/622,992

(22) Filed: Jul. 18, 2003

Related U.S. Application Data
(60) Provisional application No. 60/469,061, filed on May 7, 2003.

(51) Int. Cl. G06F 7/00

(52) U.S. Cl. 707/9

(57) ABSTRACT

An arrangement for the management and integration of web services is disclosed. The arrangement includes a transaction adapter module and a query adapter module. Each of the adapter modules includes one or more adapters. The transaction adapter module receives client requests in a client-specific protocol and translates at least a portion of the requests to a predetermined protocol. The translated portions are communicated to a service broker, which directs the queries to query services through the query adapter module in the predetermined protocol. The query adapter module translates the query from the predetermined protocol to a service-specific protocol. The predetermined protocol allows the adapter modules and the service broker to be decoupled, thus allowing dynamic loading of adapters to the adapter modules.

This application is related to U.S. Provisional Patent Application Ser. No. 60/469,061 (Atty Docket No. 028108-0201, Express Mail No. EV003592320US), filed May 7, 2003, from which priority is claimed, and which is hereby incorporated by reference in its entirety, including all tables, figures, and claims.

### BACKGROUND OF THE INVENTION

1. Field of the Invention

The invention relates generally to computer networks. In particular, the invention relates to systems and methods for the creation, configuration, deployment, use and management of services that may be provided on, for example, the world wide web.

2. Related Art

The information contained in this section relates to the background of the art of the present invention without any admission as to whether or not it legally constitutes prior art.

In today's information-intensive, networked business environment, many businesses or enterprises rely heavily on the provision of services to customers or clients through networks such as the Internet. These services are typically automated and must be flexible in recognizing the client and directing the client's requests and/or information to the appropriate server, for example.

The management of such systems has undergone a significant evolution in recent years. This evolution has been necessitated in part by the diversity of clients, varying forms of communication, and the range of services provided by the enterprise. For example, the clients may be individual users or other enterprises. Further, communication forms may now include wireless systems. Thus, the enterprise must be able to recognize clients communicating through different systems in differing protocols such as hypertext transfer protocol (HTTP), simple object access protocol (SOAP), or wireless access protocol (WAP), among others. Still further, the enterprise itself may provide a variety of services. For example, a particular enterprise may perform multiple sets of services for clients as needed. Each such service may, in turn, be required to communicate with another service, either internal or external to the enterprise. A system for managing these services must be robust enough to accommodate all these variations.

Existing enterprise web services management solutions, such as Enterprise Application Integration (EAI), represent relatively expensive ways of communicating between businesses and services. Generally, one of the greatest cost factors in the deployment and maintenance of these solutions results from the inherent proprietary nature and the incapability of seamlessly integrating with other systems or services. These current solutions tend to have many drawbacks resulting from this tight coupling, from reliance on client-server architecture, and from lack of flexibility, scalability and transparency. Further, these systems tend to be heavily centralized, making them susceptible to catastrophic failures.

It would be desirable to achieve a management method, arrangement or system which provides a distributed architecture which results in more flexibility, scalability and interoperability with other systems and services.

### BRIEF DESCRIPTION OF THE DRAWINGS

In the following, the invention will be explained in further detail with reference to the drawings, in which:

FIG. 1 is a diagrammatic illustration of a web services arrangement implementing an embodiment of the invention;

FIG. 2 is a schematic illustration of an embodiment of the transaction adapter module according to the present invention;

FIG. 3 is a schematic illustration of an embodiment of the service broker according to the present invention;

FIG. 4 is a diagrammatic illustration of an embodiment of the service engine of the service broker illustrated in FIG. 3;

FIG. 5 is a diagrammatic illustration of an embodiment of a service node in the service engine illustrated in FIG. 4;

FIG. 6 is a diagrammatic illustration of one embodiment of a graphical user interface (GUI) for use with the present invention;

FIGS. 7A-7F illustrate screen shots of an embodiment of a GUI for use with the present invention;

FIG. 8 is a diagram illustrating the processing flow for a client request in a system according to an embodiment of the present invention;

FIG. 9 is a diagram illustrating the control flow for a client request in a system according to an embodiment of the present invention;

FIG. 10 is a diagram illustrating an embodiment of the policy structure according to an embodiment of the present invention;

FIG. 11 illustrates an implementation of the policy structure of FIG. 10 in the platform of the arrangement illustrated in FIG. 1;

FIG. 12 is an exemplary illustration of one implementation of security policy in an embodiment of the present invention; and

FIG. 13 illustrates an arrangement including multiple service brokers in an extended enterprise.

### DESCRIPTION OF CERTAIN EMBODIMENTS OF THE INVENTION

The present invention provides a system and a method for managing and configuring web services. Embodiments of the invention allow businesses, or enterprises, to model business processes in service-oriented, rather than product-oriented, manner. The disclosed embodiments of the invention offer significant improvements in flexibility and cost of the management of services available through networks such as the Internet. A preferred embodiment of the system takes advantage of several aspects of the invention, including a matrix technology gateway, a component-based architecture and a graphical user interface.

Matrix Technology Gateway

An aspect of the invention, referred to herein as “matrix technology gateway”, allows for an integrated system in which various components are de-coupled and allow communication from any front-end user to any back-end resource to fulfill a client request. FIG. 1 illustrates one embodiment of an arrangement according to the present invention in which a matrix technology gateway may be implemented. The arrangement 100 allows a client 102 to access services 104 that may be offered through a business process 106. The client 102 may be an individual user accessing the services 104 through, for example, an Internet service provider (not shown). In other embodiments, the client 102 may be an application program interface (API) client requesting one or more services.

Similar to the variations in the nature of the client 102, the requests from the client 102 may also vary in their format or protocol. For example, a client who is an individual user is likely to be using a web browser. Requests from this client are likely to use the hyper text transfer protocol (HTTP). Other individual clients may use wireless devices for such requests, and these requests would use the wireless access protocol (WAP). Still other clients may use different protocols, including simple object access protocol (SOAP), a messaging protocol based on the extensible markup language (XML).

A web-services platform 110 is provided to manage the interaction between the client 102 and the services 104. The platform 110 includes a transaction adapter module 120 for receiving requests from the client 102. The transaction adapter module 120 is adapted to receive the requests in any number of predetermined protocols, to extract the query and to translate them into a standard-based format, such as XML. As indicated by the double-arrowed line 103, the transaction adapter module 120 may also be used to translate responses to the appropriate protocol for the client 102. The transaction adapter module 120 is described in further detail below with reference to FIG. 2.

Referring again to FIG. 1, the platform 110 also includes a service broker 130. The service broker 130 can receive signals from the transaction adapter module 120, extract a query, and use its resources to fulfill the client request. In this regard, the service broker 130 interfaces with a query adapter module 140 provided in the web-services platform 110. The query adapter module 140 is similar to the transaction adapter module 120 in many regards, but is adapted to allow the service broker 130 to access back end systems 108 which may be required to fulfill a client request. The service broker module 130 is described in detail below with reference to FIGS. 3-5.

Referring now to FIG. 2, the transaction adapter module 120 will be further described. The transaction adapter module 120 is adapted to receive external transaction requests from clients, as described above. The transaction adapter module 120 may be capable of screening the transaction request through admission control and authentication, for example. Further, the transaction adapter module may be provided with the capability to check for viruses embedded in the transaction requests, for example. This security aspect of the adapter is described in detail below as part of the description of component-based architecture. As illustrated in FIG. 2, the transaction adapter module 120 includes a request intake module 124 and a policies module 126.

The request intake module 124 includes a request director module 122. The request director module 122 is capable of determining the particular client type. For example, the director module 122 may be provided with software, hardware or firmware to determine whether the request is being received from an HTTP client, a WAP client or a SOAP client. The director module 122 may be adapted to recognize any number of known client types and can be modified for additional client types as they become available or necessary. As described below with reference to the graphical user interface (GUI), the configuration of the adapters, including adding or removing adapters, can be performed dynamically without interfering with the remainder of the system.

The request intake module 124 is also provided with a plurality of adapters, such as HTTP adapter 128. The director module 122, after determining the client type, forwards the request to the appropriate adapter 128. Each adapter 128 converts a client request from the client's format to a format that may be specific to the platform 110. In one embodiment, each adapter 128 converts the message to an XML-based message. More preferably, the converted message is a SOAP message.

The policies module 126 contains policies relating to various aspects of the platform or services. For example, the policies module 126 may contain policies relating to security (such as authentication) and available resources. Further, policies relating to each client type, or protocol, may be provided. The policy aspects are described below in further detail as part of the description of component-based architecture.

When a client request is received by the transaction adapter module 120, it is first received by the director module 122. The director module 122 determines the client type and directs the message to the appropriate adapter 128. The policies from the policy module 126 may be applied to each client request at either the director module 122, the adapter 128, or both. For example, in one embodiment, the security policies may be applied when the message is first received by the director module 122 to ensure the client request is valid. The protocol-specific and resources policies may be applied at a later point within the request intake module 124. The client request may be processed by the adapter 128 to forward the client request to the service broker.

The forwarded request may be a message presented to the service broker using a Web Services Description Language (WSDL) definition for the service broker to generate SOAP messages. The advantage of using a platform-independent language such as SOAP is that the transaction adapter module and the service broker are effectively de-coupled and are made independent. In this regard, the de-coupling allows the various components to operate independently, and allows them to be integrated with other components. For example, one service broker may easily communicate with one or more transaction adapter modules. Thus, each module may replace only a portion of an existing system, such as a legacy system, providing a modular replacement capability.

Thus, the transaction adapter module 120 allows any client to submit transaction requests to a service broker. In one example, if a user named Joe Smith requests a summary of all his bank accounts, the client request may appear as:

uri= <http: / /query.account.com>
query= ‘account summary’
account = ‘all’
type = ‘brief’
name=‘Joe Smith’

A WSDL definition may be provided for each requested service or set of services. For example, for the uri above, the following WSDL definition may be applied to the client request:

<?xml version=“1.0”?>
<wsdl:definition name = “accountQuery”
etc ...

For additional detail on WSDL, reference may be made to the WSDL specification, available at http://www.w3.org/TR/wsdl, which is hereby incorporated by reference in its entirety. The transformed SOAP message to be forwarded to the service broker may appear as:

...
<SOAP-ENV:Body>
<q xsi:account=‘all’/>
<q xsi:type=‘brief’/>
<q xsi:name=‘Joe Smith’/

This message may then be forwarded to a service broker for processing or fulfillment of the client request regardless of the client type of the original request. FIGS. 3-5 illustrate various aspects of one embodiment of a service broker 130 according to the present invention. The service broker 130 receives the converted client request from the transaction adapter module 120 (as described above with reference to FIG. 2) and functions to fulfill the request using the various services provided by the enterprise. In doing so, the service broker 130 may access services and resources through the query adapter module 140 (FIG. 1). Once the requests are fulfilled, the service broker 130 prepares a response for the client. The service broker 130 then forwards the response to the transaction adapter module for forwarding to the client. In this regard, the service broker module 130 serves as an intelligent hub for the fulfillment of the client requests.

In one embodiment, the service broker 130 uses a scripting language to define the logic. As described below, the logic may be used to define nodes of services, thereby facilitating efficient configuration of the services and related policies. In this regard, a graphical user interface (GUI) may be provided to allow an administrator to interact with the scripting. One embodiment of a GUI is described below.

In the embodiment illustrated in FIG. 3, the converted message is received in the service broker 130 by a query isolation module 132. The query isolation module 132 parses the converted message to retrieve one or more queries per the client request. In this regard, a query may identify one or more transactions being requested by the client. If a client request contains multiple queries, the query isolation module 132 may separate each query into a discrete task. For example, in the above example, the XML/SOAP message received from the transaction adapter module 120 requested account information for all accounts. The query isolation module 132 may use transaction definitions provided within the query isolation module 132 to determine that the transaction requires a query of account parameters and a second query of individual accounts.

The parsed queries are transmitted by the query isolation module 132 to a dispatcher 134. The dispatcher 134 provides a management function which may include, for example, allocation of resources. The dispatcher 134 may be linked to a configuration module 136 which contains policies relating to particular clients and resource allocation. These policies are generally applied on a query-by-query basis. The dispatcher 134 may also function to prioritize queries based on, for example, the nature of the client. For example, if the client is a partner of the enterprise entitled to priority, the dispatcher 134 may bypass a queue and immediately allocate resources for the query.

The dispatcher 134 passes the queries to a service engine 138. The service engine 138 operates on the SOAP or XML message and, using a set of stored service definitions, maps the query to one or more service nodes. In one embodiment, the service engine 138 uses XML style sheets (XSLT) or trees generated for each query or service. In this regard, each query may be mapped to a particular node or set of nodes within a service. In other embodiments, the service engine 138 may operate on the SOAP message by a variety of other means, including transformations, native operations and programs, and calling other web services.

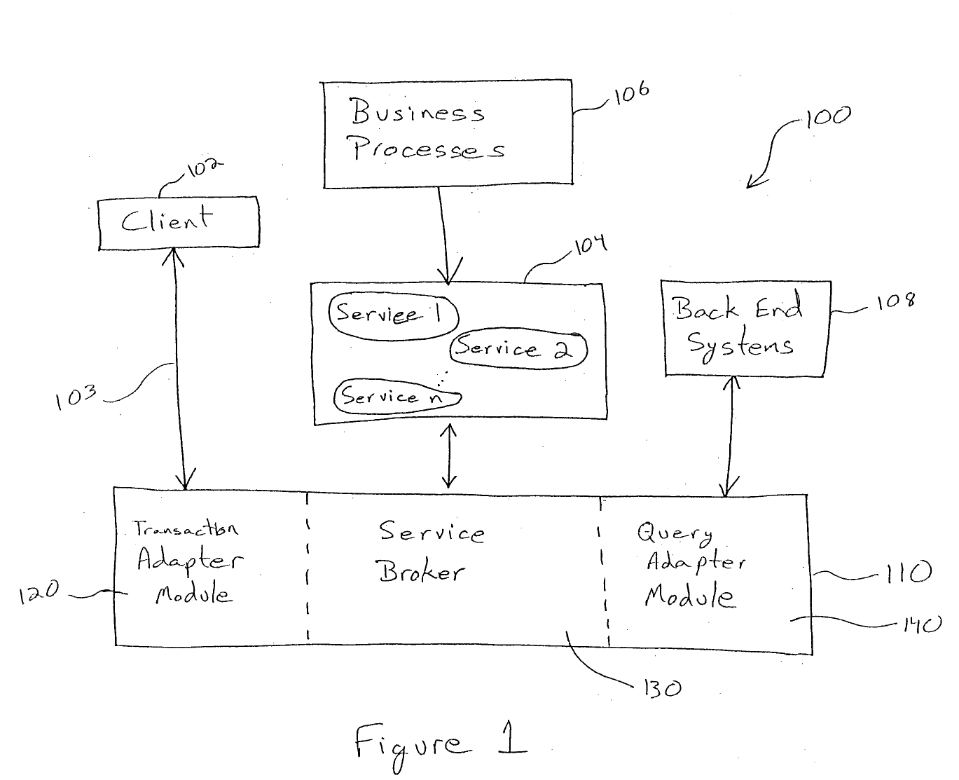

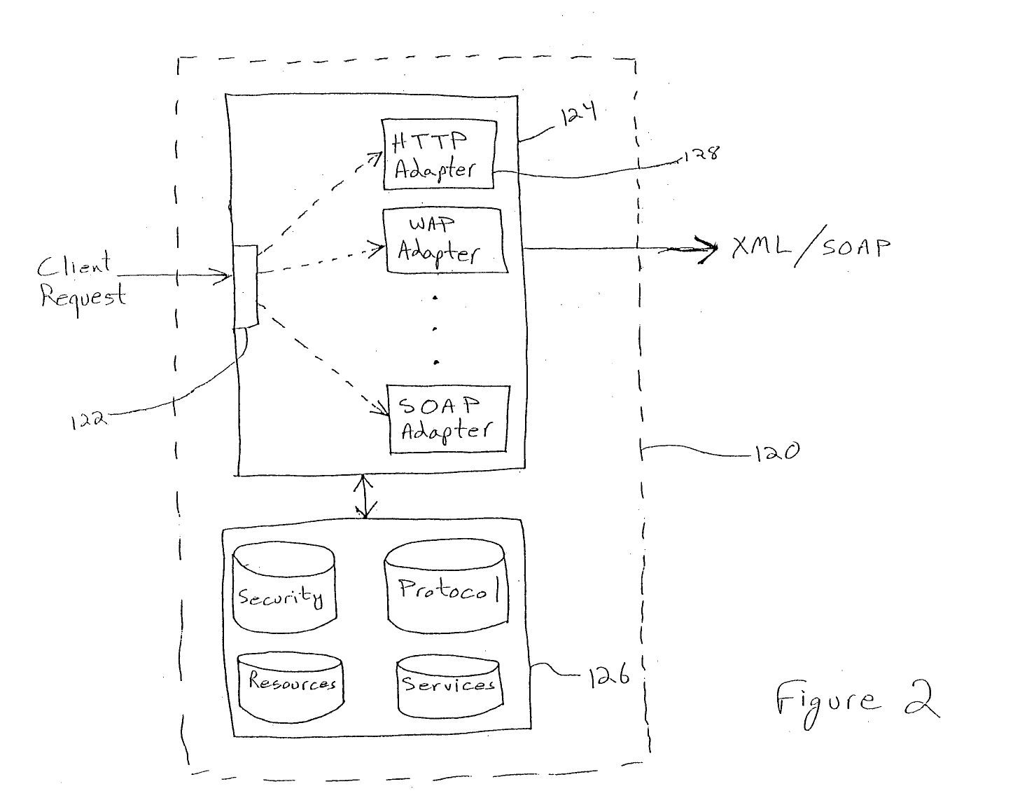

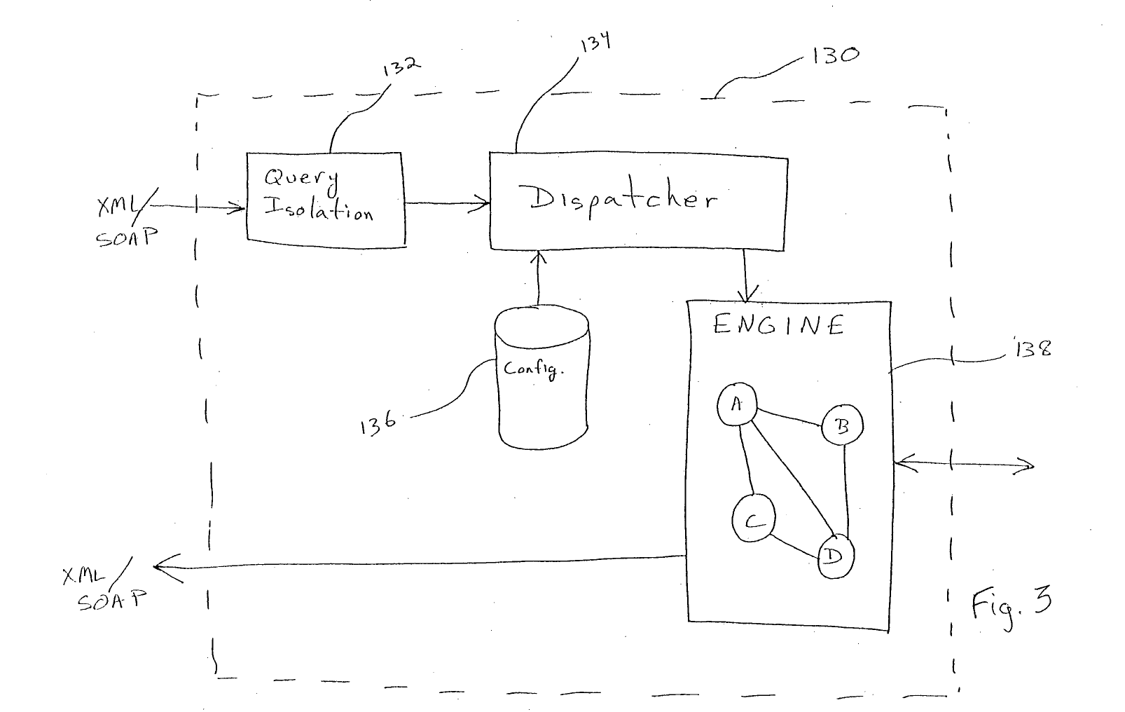

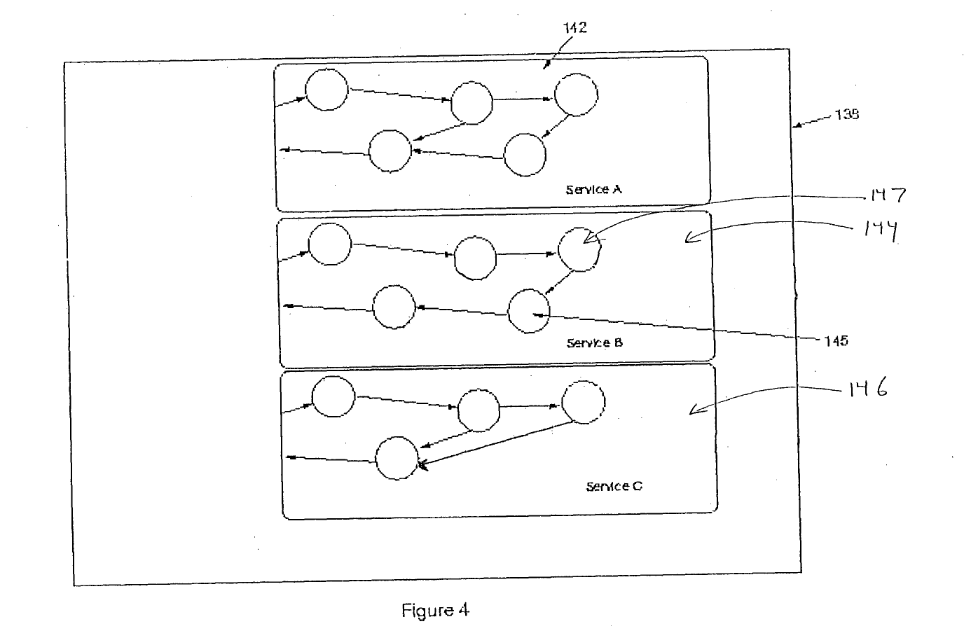

FIG. 4 illustrates one embodiment of the service engine 138 according to the present invention. Services A 142, B 144 and C 146 represent arbitrary services that may be currently selected to operate in a particular instance of the engine. Contained within each service are operational nodes, such as nodes 145, 147 in service B 144. Each service may be configured with an arbitrary number of nodes as required for the particular operation it is to perform.

The arrangement of various operations into services of nodes is preferably achieved through embedded logic or artificial intelligence. The arrangement is preferably optimized to minimize the costs associated with the services or to maximize a return on an investment into the enterprise. In this regard, each service 142, 144, 146 includes a cluster of nodes or operations which, for example, are most likely to be executed as a group. The embedded logic or artificial intelligence may generate an optimum configuration. By optimizing, the execution times and maintenance costs for the services to fulfill a client request can be substantially reduced. At the same time, flexibility is retained since each operation may be part of more than one service and each service can be linked to other services, as described below.

The optimization of the configuration may be achieved through any of several known mechanisms. For example, a rules-based engine may be used to yield an optimum configuration based on a set of predetermined rules. In other embodiments, a tree optimizing algorithm may be implemented. In still other embodiments, a “peep hole optimization” may be utilized, for example, to examine a plurality of operations for evaluation of the benefits of merging two or more of the operations. Other optimization techniques will be apparent to those skilled in the art.

In certain embodiments, the optimization may be made adaptive. In this regard, the embedded logic or artificial intelligence may periodically evaluate trends or tendencies in the client requests to re-optimize the configuration. Logs of client requests may be used for such an evaluation.

Each node within a service represents a particular operation to be performed pursuant to a client request. Each node may correspond to a specific operation or to another service. For example, it would be possible for node 147 of Service B 144 in FIG. 4 to correspond to an instance of Service A 142. Thus, when Service B 144 is executed, Service A 142 is executed as corresponding to node 147, in addition to the execution of the other nodes in Service B 144, such as node 145.

Each service 142, 144, 146 includes one or more nodes, each node corresponding to an operation or a service. The service engine 138 uses XSLT to map each node or operation to an appropriate back-end, or query, adapter in a query adapter module 140 (shown in FIG. 1). Thus, a query is mapped to a service, which in turn is mapped to one or more nodes and operations, each of which are mapped to an appropriate back-end adapter. In this regard, the service engine 138 encapsulates each operation request in an XML/SOAP message for transmission to back-end service through a query adapter. The encapsulation may alternatively be performed by the query adapter. The query adapter can then convert the XML/SOAP message to a format or protocol appropriate for the desired service. Thus, as described above with reference to the transaction adapter module, the query adapter module 140 is also effectively de-coupled from the service broker module 130. The query adapter module 140 may also apply a set of policies, similar to the policies described above with reference to FIG. 2 and described in detail below as part of the description of component-based architecture.

Within the service engine 138, the responsibility for the client request may be transferred to the service accommodating the request. Further within each service, the responsibility may be handed off to the various nodes as an operation is completed at each node. In this regard, the transfer of responsibility may be achieved through a WSDL message. The WSDL message can retain an identifier of the client submitting the request including the client type. In this manner, once the request has been fulfilled, the service engine 138 is able to transfer the response to the appropriate adapter in the transaction adapter module.

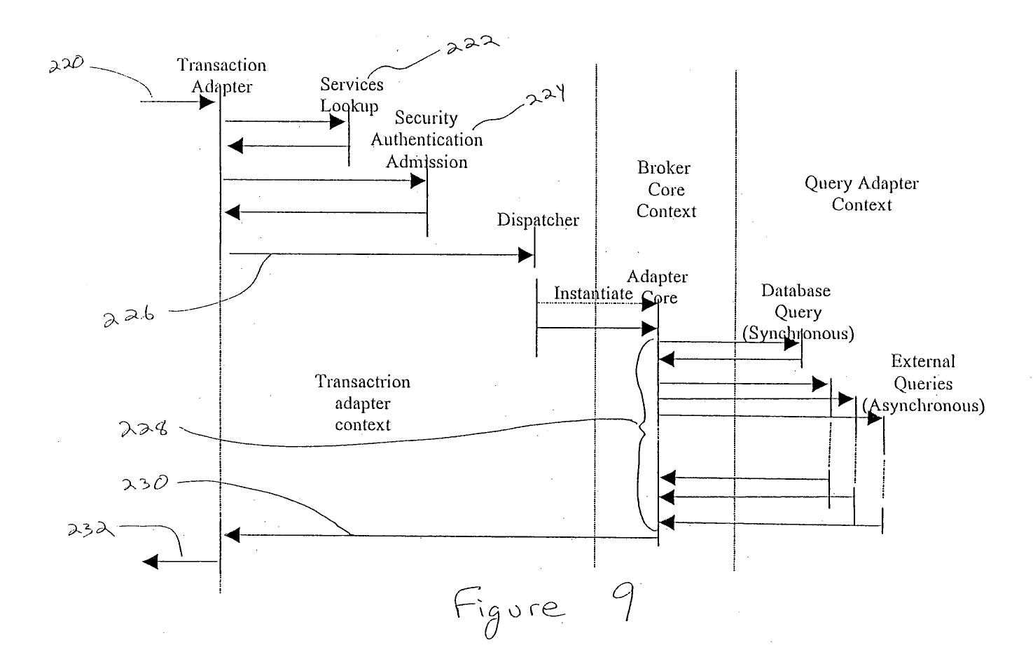

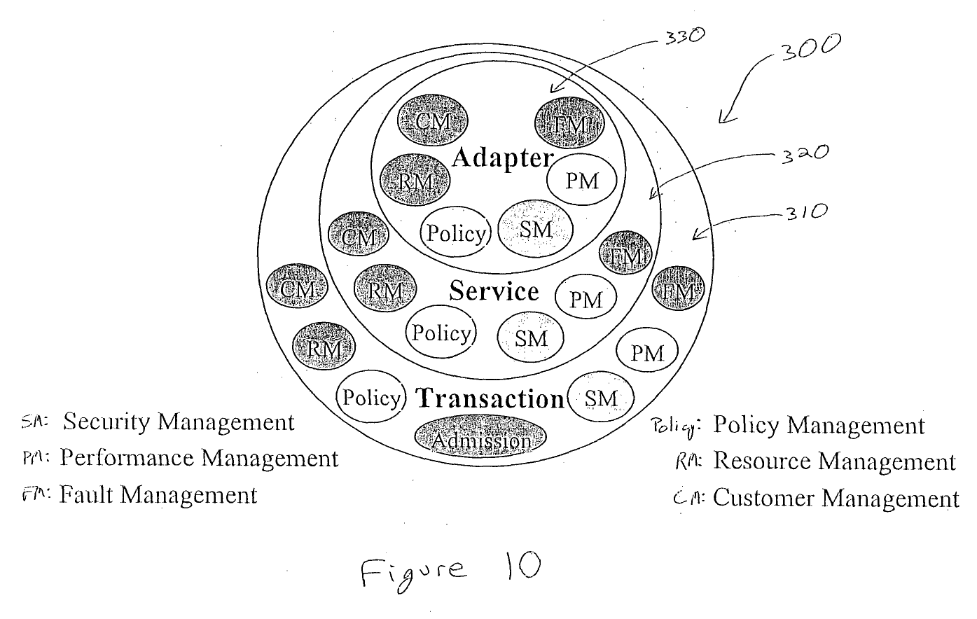

FIGS. 8 and 9 illustrate the overall process and control flow of a client request in the arrangement illustrated in FIG. 1. Referring first to FIG. 8, a client request 202 is received by the transaction adapter module as, for example, a SOAP-based request. The client request 202 may be parsed into a transaction query 204 in a standard-based language such as XML for validation. Validation may include application of several aspects of policies including security. Upon validation, the query 204 may be forwarded to the service broker as a service request 206. Again, a standard-based language such as XML is preferably used. The service request 206 may be mapped to one or more operations 208 requiring access to one or more back-end adapters and services. Once the client's request has been fulfilled, the service broker can prepare a response 210, 212 for forwarding to the client.

FIG. 9 illustrates the control flow of a client request processed by the arrangement illustrated in FIG. 1. A client request 220 received by the transaction adapter module may first require authentication and/or validation prior to being admitted to the platform. While retaining control of the client request 220, the transaction adapter module may perform validation and authentication through, for example, services lookup 222 and security authentication admission 224. Upon satisfaction of these pre-defined criteria or policies, the transaction adapter module may transfer control to the dispatcher (through line 226), which forwards the request to the service broker module. The service broker module may apply additional policies at this level, as described in detail below. Based on the application of these policies, the service broker module may process the client's request, which may be mapped to one or more operations 228 requiring access to one or more back-end services. Upon fulfillment of the client's request, the service broker module may prepare and forward a response 230, 232 to the client.

Thus, the matrix technology gateway provides a platform that can be integrated, yet allows the service broker to be de-coupled from the transaction adapter module and the query adapter module. The use of a platform-independent or universal language, such as XML/SOAP, provides access for any client type to any service or back-end resource. Further, the use of embedded logic or artificial intelligence to optimize configuration of services provides the enterprise with maximum benefit. Thus, complete flexibility is achieved in three dimensions: client type, services and back ends.

Further flexibility and integration may be achieved through an extended enterprise arrangement as illustrated in FIG. 13. In this arrangement, two or more service broker modules may be linked to provided even greater interaction between a larger set of clients, a larger set of services, and a larger set of back ends. For example, two partner enterprises may link their service broker modules to combine their services and resources without significant additional expense. This can be achieved due to the de-coupled nature of the three stages.

Component-Based Architecture

Another aspect of the invention is the component-based architecture which allows for a flexible and scalable arrangement with a deep level of configurability. In this regard, various policies can be implemented and applied at any selected level of resolution desired by a configuration manager.

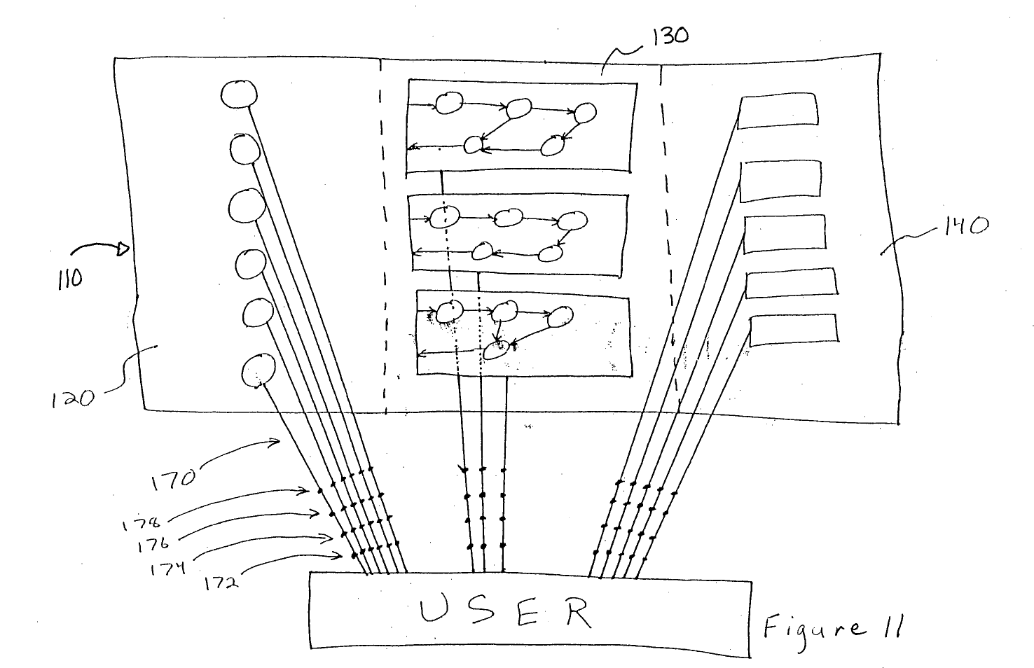

FIG. 10 illustrates one embodiment of a policy structure according to the present invention. In the illustrated policy structure 300, different aspects of policies are configurable at multiple levels 310, 320, 330. At an uppermost level, the transaction level 310, a set of policies are configurable, including security management, performance management, fault management, resource management and customer management. In addition, the uppermost level, the transaction level 310, also includes admission policies which are applicable to each client request received by the enterprise. Further, additional policy classes may be added through the GUI.

In a similar manner, each level 320, 330 below the transaction level 310 allows configuration of the various policy aspects. As illustrated in FIG. 10, the service level 320 and the adapter level 330 contain configurable policy aspects including security management, resource management, performance management, fault management, and customer management. The various policy aspects are described below and are preferably configurable through the graphical user interface (GUI).

Security Management. Security is an integral part of the framework of the above-described system and is preferably dynamically configurable. The security management configuration may include an application-level firewall to guard against hacking. In a preferred embodiment, the security management is configurable at each level. At the transaction level, in addition to the firewall, security management may include authentication through use of user ID's and passwords, digital signatures, certificates, trusted sites and the like. Further, transaction-level security management may include XML encryption, as described below, to prevent exposure to malicious material such as scripted worms. At the system level, security management relates to the execution environment. At the link level, security management is associated with adapter security policies. Security at this level may be implemented at the encryption/decryption layer, data transport layer or the firewall layer. Each parameter associated with security management at each level may be provided with a default, but may be independently configurable by the user.

One aspect of security management is admission policy, which allows configuration of admission classes. Each admission class may specify further policy aspects, such as resource and security. Additionally, admission policy configuration may specify access lists and password lists.

Resource Management. Resource management defines the availability of system resources and may be used as a reference in admission control. Resources may be diverse, including available ports or protocols, a maximum number of instances per component and request timeouts. Resource management may include policy-based clustering, which may also be configurable by the user. Such clustering may include priority routing and resource allocation, for example, of partners.

Performance Management. Performance management may include policies and parameters relating to generation of alarms of faults. It may also include monitoring of service performance, including execution times, failures, retries, number of hops, etc. In addition to service performance, resource usage may also be monitored. In this regard, parameters relating to resource usage and load balancing may be monitored and event logs and fault triggers may be defined.

Fault Management. The system includes a dynamic component-based fault management. In this regard, faults are preferably cleared at the lowest possible level, depending upon the severity, granularity, context and policies relating to the particular fault. The transaction state may be cached at each level to facilitate recovery. Fault management and the related failure recovery may be administered at each level, including transaction failure, system failure and link-level failure. For transaction-level failure, fault management may define a level of rollback of transaction implemented as check-points and restarting of transactions at various levels. Fault management may also provide for alternatives available in the event of a failure. The alternative operations may be initiated upon detection of the failure. For system-level failures, fault management may include multiple registries and multiple broker instances. At the link level, fault management may include providing multiple port connections. Further error recovery and alternate routes may be provided.

Customer Management. Customer management may include maintaining customer profiles, including client type and identity. Further, billing information, customer activity logs and access policy may be maintained.

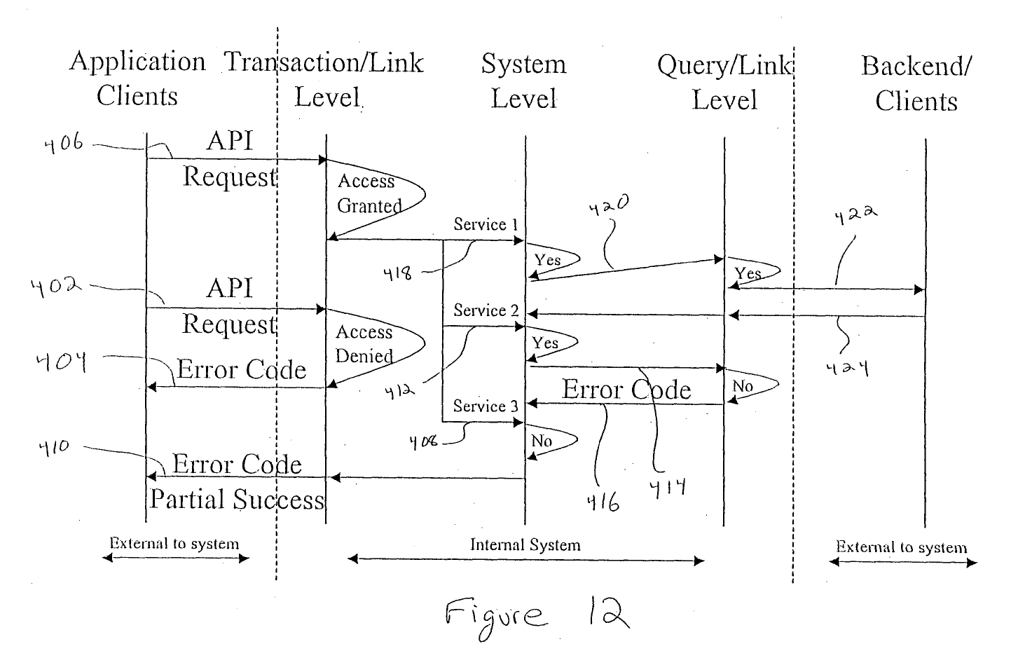

As noted above, each policy aspect is preferably configurable at each level. FIG. 11 illustrates such an implementation in the platform 110 of FIG. 1. A user may access the platform through a GUI and can access each component at each level. In the illustrated example, the user can access each adapter in the transaction adapter module 120, each service in the service broker 130 and each back-end adapter in the query adapter module 140. Access of these components is indicated by the lines 170. Access of each component includes configurability of each policy aspect (indicated by hubs 172, 174, 176, 178). Thus, the user can configure each of security management, performance management, fault management, policy management, resource management and customer management for each component at each level. Preferably, a GUI with a drag-and-drop capability is provided to facilitate configuration by the user.

Additionally, configurable service management may include a service directly listing available services. A security set and a resource set per service may be defined through service management. Service management may interact with admission requirement policies.

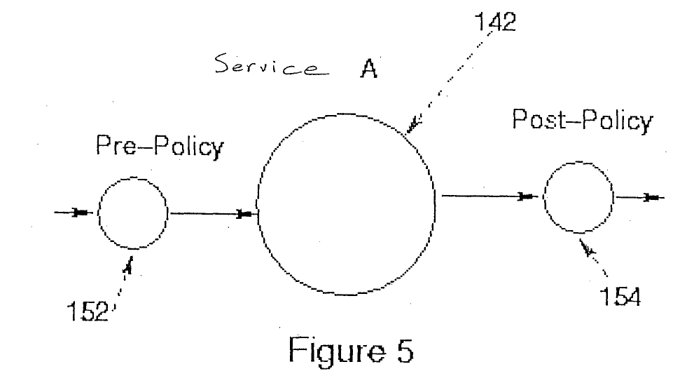

In one embodiment, the service engine 138 can apply a set of policies to each service 142, 144, 146. In this regard, by allowing clustering of the operations into services, the present invention allows a configuration at any desired level. For example, FIG. 5 illustrates one embodiment of a configuration according to the present invention. In this illustration, a service of any number of nodes or operations may be configured with a single set of policies 152 applied prior to the access of the services of Service A 142 and a single set of policies 154 after accessing the service. For example, a set of security policies may be applied to a set of services together. In order to apply different policies to services within a node, the service engine may be re-configured to break up the node into two or more nodes with different policies applying to each node. Thus, any level of resolution at which configuration is desired may be achieved at the lowest possible cost. To reduce cost, a large number of services may be included within a single node and may use the same set of policies.

Similarly, policies can be applied at any step in the process at any desired level. For example, at the transaction adapter illustrated in FIG. 2, a first set of policies may be applied to all levels of users, or a unique set of policies may be applied to two or more groups of users. For example, a single set of services policies may be applied to users of all client types, while different sets of security policies are applied to each client type. This may be instituted since some client types may be more prone to security problems, such as virus susceptibility. Further, a set of policies may be applied at the director module 122, and a different set of policies may be applied at each adapter.

Thus, the architecture allows configuration at a desired level for each component of the system. This may be accomplished for each of a set of policy categories, including security, at each of several levels such as general, user, service or activity.

For security, the primary focus is external security based on link and message encryption to ensure privacy, trust and authentication. Security includes encryption to provide message security and system security. Encrypted messages are received by the system and are decrypted for extraction of the client request. However, various levels of the message may be decrypted separately. For example, encrypted fields within the SOAP message may not be immediately decrypted to prevent exposure to concealed data such as viruses. Once the source of the message (i.e., client) has been identified as a trusted client, the message may be completely decrypted.

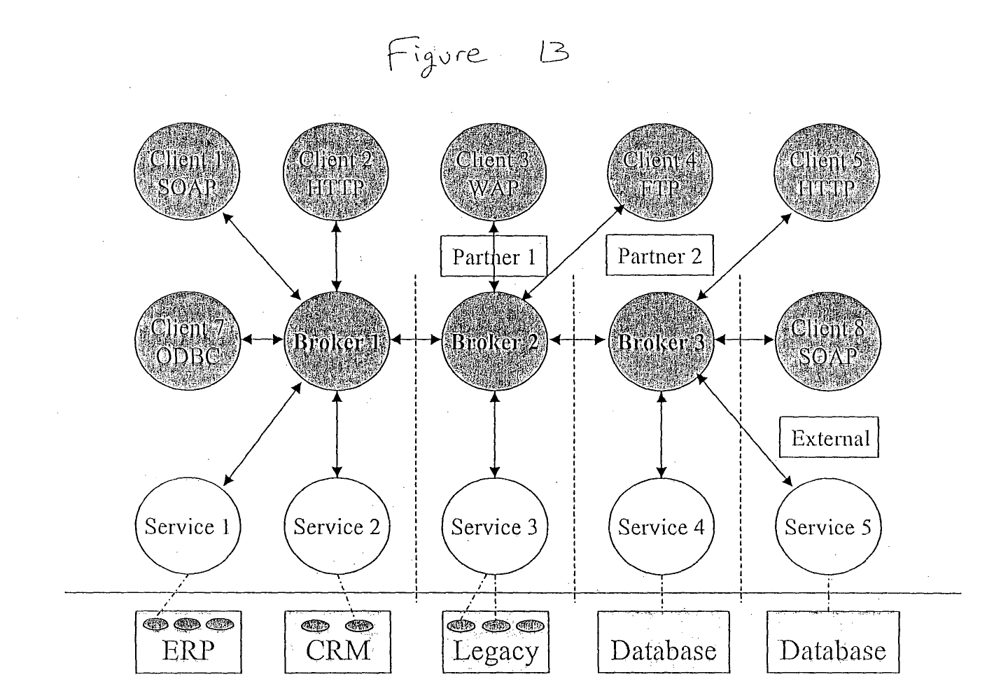

FIG. 12 illustrates an example the implementation of the security policies at various levels. FIG. 12 illustrates a plurality of client requests received by the enterprise, each having security policies applied thereto. A first client request 402 is received by the transaction adapter module, and security policies are applied. In the illustrated example, the client request does not satisfy the configured security policies, and access is denied. An error code message 404 is returned to the client. A second request 406 is received by the transaction adapter module, and satisfies the security policies. Thus, the client request proceeds to the system level. At this level, each client request may be parsed into one or more services. In the illustrated example, the request is parsed into three services 408, 412, 418. System-level security policies are applied to each service request 408, 412, 418, resulting in one service request 408 being denied. The remaining two service requests 412, 418 are granted and are forwarded as service requests 414, 420 to the query level. At this level, service request 414 is denied, resulting in an error code being returned to the system level. The remaining service request 420 is granted and is forwarded to the back-end adapter for fulfillment of the service (lines 422, 424) with a message being transmitted to the system level. The system level then transmits a partial-success error code message 410 to the client due to failures of two service requests 408, 412.

In addition to security, other categories of policies may also be implemented on a component and level basis. Such categories may includes resources, services, fault management, etc. Again, these may be applied at any step of the process at any desired level of resolution. Thus, complete flexibility and scalability can be achieved.

Graphical User Interface

The configuration of each stage and management of the system, for example, may be performed through a graphical user interface (GUI). The GUI may be implemented at either a remote or a local management system. Further, since each stage is de-coupled, re-configuration of the individual stages may be performed without taking the other stages off-line.

The GUI can serve many functions. First, it serves to present data in an understandable format. Second it facilitates manipulation and configuration of the data and/or system by readily allowing additions or revisions of policies or additions or removals of various adapters, for example. Third, it may include the above-described embedded logic or artificial intelligence for optimization of the configuration of services. Finally, it may include certain associated services to facilitate policy management.

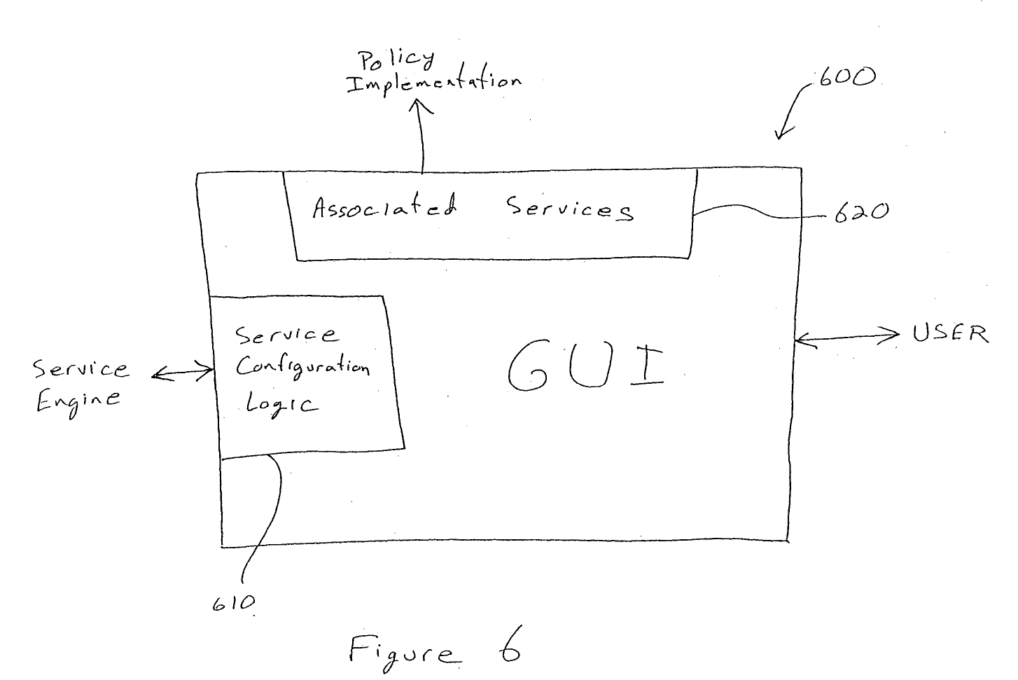

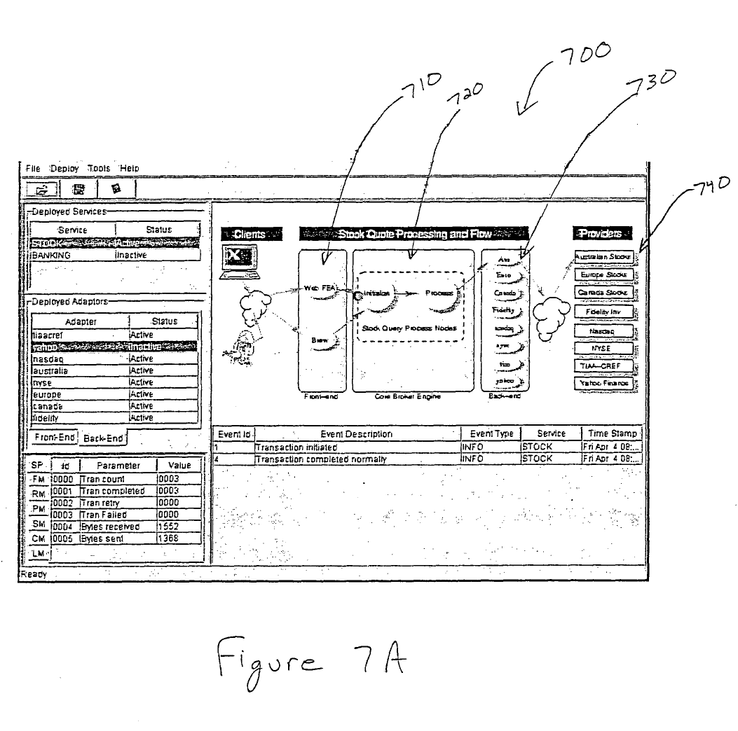

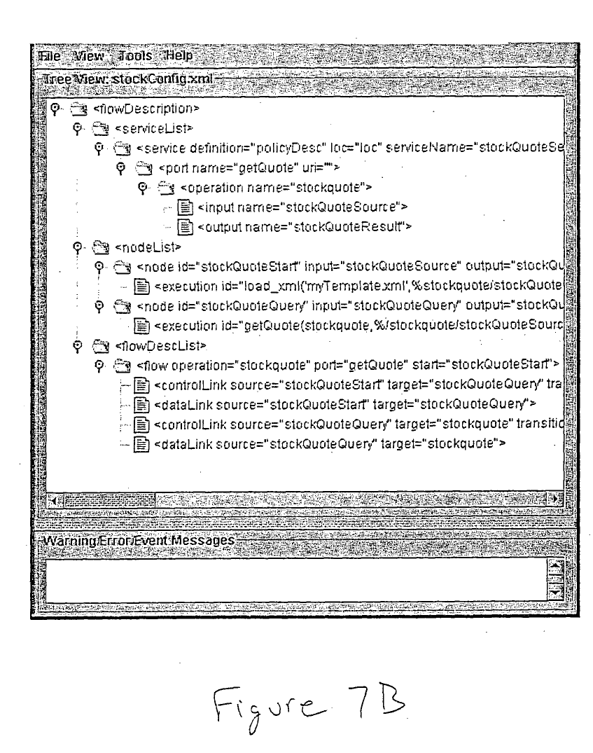

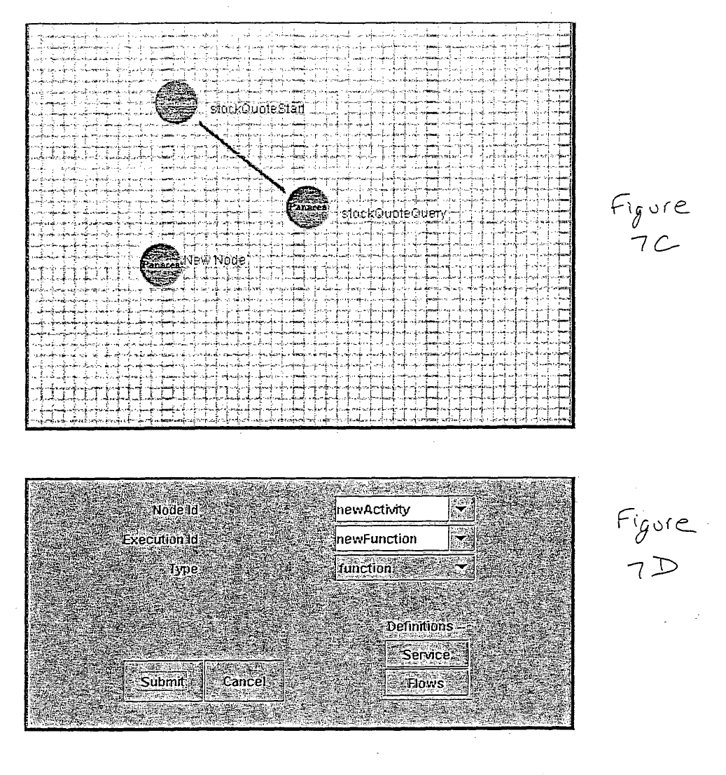

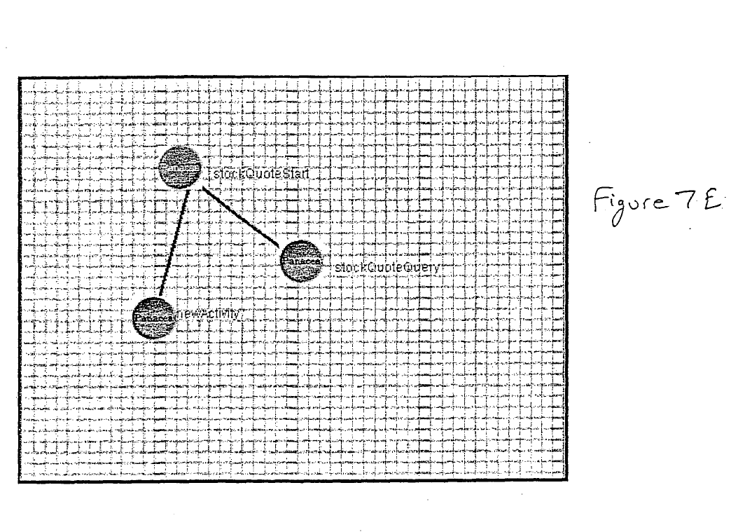

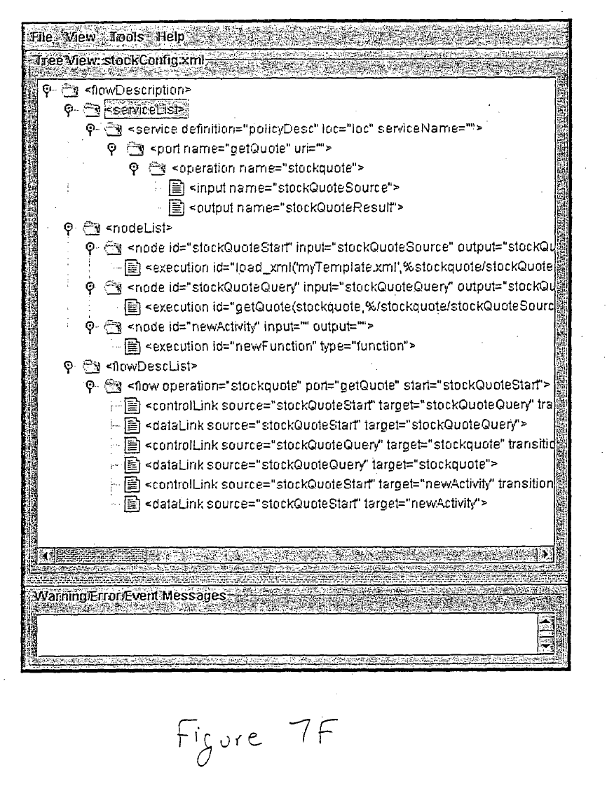

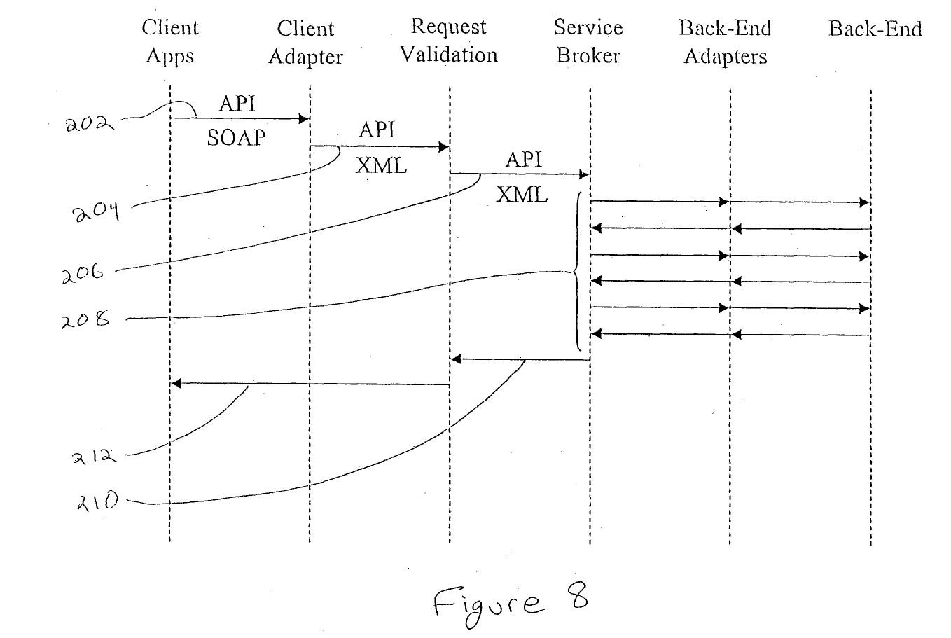

FIG. 6 is a diagrammatic illustration of one embodiment of a GUI for use with the present invention. The GUI 600 includes software for presenting information to a user in an understandable format. Preferably, the information is presented in a graphical format as illustrated below with reference to FIGS. 7A-7F. In this regard, complex relationships and information can be presented in a readily understandable and manipulable format to a user. Thus, a user can, by simply clicking and dragging an icon, for example, change the configuration of an aspect of the system.

The GUI 600 may also include the above-described embedded logic 610 for optimizing the configuration of the services into clusters, for example. In this regard, the logic 610 may include, as inputs, information from the user or the service engine as to tendencies or trends in the operation of the system. Thus, the embedded logic 610 can adapt and reconfigure the services to optimize the services on a regular, ongoing basis.

The GUI may also be provided with a set of associated services 620 for facilitating configuration and implementation of the policies. These associated services may receive inputs from the user as to the desired configuration and may determine the appropriate implementation of the desired configuration. For example, the user may input two sets of policies for two sets of users, one a preferred set and another a standard set. The associated services 620 may then implement that desired configuration as two sets of policies using additional information. For example, information from another source may indicate that preferred users are WAP users, while standard users use all other protocols. The associated services 620 may then configure the two set of policies with the first applying to all users using WAP and the second to all other users.

The GUI may generate a logical structure in a work flow language such as WSFL, which is expressed as an XML file. Additionally, the GUI may generate policy information, which is also represented as an XML document. In doing so, the embedded logic 610 may dictate configuration of the polices at each level and at each step. The embedded logic 610 may generate XML stylesheets to facilitate the configuration by providing mapping information.

FIGS. 7A-7F illustrate the operation of an embodiment of a GUI according to the present invention. The GUI is demonstrated in FIGS. 7A-7F as implementing a configuration change in a readily understandable manner.

FIG. 7A is a screen shot illustrating an overall view of a service for obtaining stock quotes. The service 700 includes a set of front-end transaction adapters 710. In the illustrated configuration, two transaction adapters are provided: Web FEA and Brew. A service engine 720 receives the client requests through the transaction adapters 710 and access services 740 through one or more query adapters 730. In the illustrated embodiment, a different transaction adapter is provided for each back-end service. The service engine 720 includes a single cluster of two nodes.

FIG. 7B illustrates an XML tree corresponding to the configuration illustrated in FIG. 7A. Note the number of nodes in the nodeList corresponds to the number of nodes in the service engine 720.

FIGS. 7C and 7D illustrate an attempt by a user to add another node to the service engine 720. In this example, a new node is created by selecting a new function node in the GUI (FIG. 7D). A new node is then shown graphically as part of the service engine 720 (FIG. 7C).

In FIG. 7E, the new node is labeled and configured as being linked to one of the present nodes. The new node is labeled as “newActivity” and is linked to one of the existing nodes.

FIG. 7F illustrates the updated XML tree after the implementation of the change in configuration. Now the nodeList contains the three nodes, including the newly added “newActivity” node. The new node is associated with a certain function which the user desires to execute as part of the conferect.

Thus, the GUI enables fast and easy configuration or reconfiguration of the system. The GUI may be used to easily change the configuration of other aspects of the system. In particular, policy changes may be readily implemented.

While particular embodiments of the present invention have been disclosed, it is to be understood that various different modifications and combinations are possible and are contemplated within the true spirit and invention. There is no intention, therefore, of limitations to the exact disclosure or abstract herein presented.

We claim:

1. An arrangement for web services management or integration, comprising:
a transaction adapter module for receiving client requests in a client-specific protocol and having one or more transaction adapters, each of said transaction adapters for translating at least a portion of said client request to a predetermined protocol; and
a query adapter module for communication with a set of query services and having one or more query adapters, each of said query adapters for translating at least a portion of said client request from said predetermined protocol to a service-specific protocol;
wherein said transaction adapter module and said query adapter module are modularly interfaceable with a service broker adapted to direct queries to said query services, and
wherein said predetermined protocol allows said transaction adapter module, said query adapter module and said service broker to be decoupled, thereby allowing dynamic loading of adapters to at least one of said transaction adapter module and said query adapter module.

2. The arrangement according to claim 1, wherein said transaction adapter module is adapted to isolate a query within said client request.

3. The arrangement according to claim 2, wherein a WSDL definition is used to present said isolated query to said service broker.

4. The arrangement according to claim 1, wherein said predetermined protocol is XML-based.

5. The arrangement according to claim 4, wherein said predetermined protocol is SOAP.

6. The arrangement according to claim 1, wherein said transaction adapter module is adapted to apply a set of policies to said client requests.

7. The arrangement according to claim 6, wherein said set of policies is predetermined.

8. The arrangement according to claim 6, wherein said set of policies is dynamically configurable.

9. The arrangement according to claim 6, wherein said set of policies includes client authentication.

10. The arrangement according to claim 6, wherein said set of policies includes security management.

11. The arrangement according to claim 6, wherein said set of policies includes performance management.

12. The arrangement according to claim 6, wherein said set of policies includes fault management.

13. The arrangement according to claim 6, wherein said set of policies includes resource management.

14. The arrangement according to claim 6, wherein said set of policies includes customer management.

15. The arrangement according to claim 1, wherein said query adapter module is adapted to apply a set of policies to said client requests.

16. The arrangement according to claim 15, wherein said set of policies is predetermined.

17. The arrangement according to claim 15, wherein said set of policies is dynamically configurable.

18. The arrangement according to claim 1, wherein said service broker is adapted to apply a set of policies to said client requests.

19. The arrangement according to claim 18, wherein said set of policies is predetermined.

20. The arrangement according to claim 18, wherein said set of policies is dynamically configurable.

21. The arrangement according to claim 1, wherein said transaction adapter module and said query adapter module are further modularly interfaceable with other adapter modules.

22. The arrangement according to claim 1, wherein said transaction adapter module comprises:
a director module for determining the client-specific protocol and directing the message to a corresponding adapter.

23. The arrangement according to claim 22, wherein said transaction adapter module further comprises:
a policy module for determining and applying policies corresponding to at least one of a client, a transaction and a service.

24. The arrangement according to claim 1, further comprising:
a graphical user interface for allowing a user to reconfigure at least one of said transaction adapter module and said query adapter module.

25. A web services arrangement, comprising:
a transaction adapter module for receiving client requests and having one or more transaction adapters; and
a query adapter module for communication with a set of query services and having one or more query adapters; and
a service broker adapted to receive queries from said transaction adapter module and to access service resources at least partly through said query adapter module,
wherein said service broker includes a mapping of each service to one or more operational nodes corresponding to one or more operations required to perform said service.

26. The arrangement according to claim 25, Wherein at least one node corresponds to another service.

27. The arrangement according to claim 25, further comprising:
a graphical user interface adapted to allow a user to reconfigure said mapping.

28. The arrangement according to claim 27, wherein said graphical user interface is further adapted to allow a user to reconfigure policies.

29. The arrangement according to claim 28, wherein said policies includes client authentication.

30. The arrangement according to claim 28, wherein said policies includes security management.

31. The arrangement according to claim 28, wherein said policies includes performance management.

32. The arrangement according to claim 28, wherein said policies includes fault management.

33. The arrangement according to claim 28, wherein said policies includes resource management.

34. The arrangement according to claim 28, wherein said policies includes customer management.

35. The arrangement according to claim 25, wherein said mapping is optimized for minimum cost.

36. The arrangement according to claim 35, wherein said mapping is optimized using embedded logic.

37. The arrangement according to claim 35, wherein said mapping is optimized using artificial intelligence.

38. The arrangement according to claim 35, wherein said mapping is optimized using a rules-based engine.

39. The arrangement according to claim 25, further comprising:
a graphical user interface adapted to allow a user to reconfigure business process flow management.
